(19) United States
(12) Patent Application Publication
(10) Pub. No.: US 2005/0165684 A1
(43) Pub. Date: Jul. 28, 2005

(54) Electronic transaction verification system

(75) Inventors: Gregory C. Jensen, Redmond, WA (US); Dwayne Mercredi, Alberta (CA)

Correspondence Address: WOOD, HERRON & EVANS, LLP, 2700 CAREW TOWER, 441 VINE STREET, CINCINNATI, OH, 45202, US

(73) Assignee: Saflink Corporation

(21) Appl. No.: 10/766,551

(22) Filed: Jan. 28, 2004

(51) Int. Cl. G06F 17/60

(52) U.S. Cl. 705/44

(57) ABSTRACT

An apparatus, method and program product receive remote identification data from an identification device (12) associated with a user account in response to initiation of an electronic transaction at a terminal (22). The identifying device communicates the remote identification data to a processing system (16), where it is compared against stored authentication data associated with the user account. The processing system (16) communicates verification to the terminal (22) if a match is determined, allowing the electronic transaction to proceed.

### FIELD OF THE INVENTION

The present invention relates generally to authentication technologies, and more particularly, to verifying that a transaction, such as a credit card or an electronic transaction is authorized to proceed.

### BACKGROUND OF THE INVENTION

Credit card fraud is rampant. Criminals routinely misappropriate credit cards and associated account information to perpetrate unauthorized transactions. In our technology-bound society, these transactions are often handled electronically. While the advent of electronic credit transactions has been seen as a boon, it has been accompanied by certain vulnerabilities that criminals routinely exploit, costing industry and private citizens vast amounts of money and anxiety. One such vulnerability includes the absence of an independent, transactional-based system for determining whether the electronic transaction is authorized to proceed.

More particularly, conventional electronic credit transactions presume for the sake of practical convenience and expense that the person in possession of a card or other credit account information is, in fact, authorized to access the account. For example, a restaurant patron may attempt to pay for a meal by presenting a waiter with a credit card. The waiter swipes the credit card through a card reader. The card reader electronically communicates with a processing center, which if that center recognizes the card data as a valid account, will (at least tentatively) authorize the transaction. In turn, a receipt may be printed for signature by the patron. The patron may or may not be the rightful owner of the credit card or may not otherwise be the person authorized to use the card. Similarly, online transactions proceed based on a similar presumption that the person entering some minimum amount of account identification information is authorized to charge purchases against the account.

In the common scenarios described above, if the person presenting the card or account information is not the rightful owner or authorized user, the transaction will likely be approved if the account data is otherwise valid. The result will be a loss to the credit issuer, the business involved, and/or the rightful owner of the card. Those losses can mount significantly, not to mention the frustration, anger and anxiety created for the consumers bilked by criminal and fraudulent use of their credit account information.

Efforts to battle credit card fraud are themselves costly, and often fail. Most proposals involve modifications to the cards, the readers, or other infrastructure changes that are difficult and costly to deploy, especially given that most of the cards and hardware are distributed out over millions of locations and people. Some of these proposals are impractical, while others are inconvenient and annoying. As a consequence, there exists a universal need for a more efficient, cost effective and otherwise improved manner for determining if an electronic-based credit or other financial transaction is authorized, especially without requiring new or different equipment or cards for the users and businesses that interface with consumers as part of the transaction. Similarly, many other types of electronic transactions occur where such improvements are desirable.

### SUMMARY OF THE INVENTION

The present invention provides an improved apparatus, program product and method for determining if an electronic transaction is authorized and should proceed. To this end, and in accordance with the principles of the present invention, before the electronic transaction is approved, the rightful owner or authorized user is automatically contacted via an identifying device correlated to that person who would normally be in the possession of, or otherwise accessible to, that person for verification that the transaction should proceed. When contacted, the transaction can be verified or refused through the identifying device by the rightful owner or authorized user, thus reducing substantially the risk of credit card fraud, for example. The foregoing generally capitalizes on equipment conventionally available to a user, and thus may not require changes to existing equipment and card requirements of users and businesses interfacing with consumers.

In the restaurant and online examples described above, the identifying device may be the card holder's cellular telephone. When the credit card is swiped by the waiter, or is otherwise keyed in or entered online, the processing center determines that the account is valid and that the identifying device is the cellular telephone. The system automatically calls the card holder's phone. When the owner answers, she can enter a code as a sequence of buttons or speak into the phone, depending upon the type of verification required by the processing system (which will usually be determined in advance). If the proper code is entered by button or voice, or if the speech is recognized as a biometric identifier for the owner, the transaction will be authorized and may proceed as normal at the purchasing end. If unrecognized or inaccurate, the transaction will not be authorized, and the potential that the card is being used illegally will have been terminated in that instance.

Other identifying devices may be utilized, such as personal digital assistants (“PDAs”), pagers, or other handheld or laptop devices. For example, in an online example, the identifying device may be an email or instant message (“IM”) facility accessible via the same or another communication device on which the online transaction is occurring. The authorized card holder is to enter certain responses in response to the email or IM, such as a password or the like. Or, the response may be via a biometric receiving device (such as a microphone or fingerprint reader) to receive the biometric authentifier for transmission to the central processing system for transactional verification.

The likelihood of a criminal having both the credit card/information and the identifying device is significantly lower than the odds of the criminal having just the credit card/information. Such odds are exponentially reduced where the identifying device and authentication protocol incorporate use of a password and/or a biometric identifier (referred to as a Biometric Identification Record or BIR). A BIR generally comprises an electronically stored file correlated to a unique behavioral or physical characteristic of an individual. The individual may rely on the BIR as a form of identification or authentication. Common physical characteristics include fingerprints, voice recognition attributes and hand geometry, as well as facial and retinal/iris characteristics. Behavioral characteristics generally include electronic signatures and keystroke pattern, by way of example.

To this end, one or more processing systems receive remote identification data from the identifying device. To this end, the processing system generates a request for remote data to prompt the user to enter the remote identification data into the identifying device. The request may be generated in response to the user initiating the request at a transaction terminal. The remote identification data is compared against stored authentication data associated with an account of an authorized user. While the comparison may be conducted at the identifying device, it is generally accomplished at the processing system. Verification is communicated to the transaction terminal in response to the comparison. Depending on the configuration of the transaction system, the transaction terminal either approves or denies the pending transaction.

Additionally, while there will be certain modifications necessary at the processing center(s), the major infrastructure involved at the consumer and business end is left largely untouched. Instead, the authentication involves identifying devices that the user is expected to already possess. Most are also of the highly portable variety, and are commonly carried about with the user, such as cellular phones and wireless PDAs. Each device may be taken by a consumer to the location of a transaction, obviating the need for that location to provide special authenticating hardware. Moreover, the user can be contacted anytime they choose to undertake a credit transaction, or should a third party attempt to use the credit or other account data. The ready access to the identifying device further promotes speedy authorization. The result is a cost-effective method to reduce or eliminate credit card fraud, and without the need for complicated systems of cards, readers, and other complex attacks on the problem.

Electronic transactions for purposes of this specification may include commercial transactions, as well as transactions involving access to controlled data, services or equipment. The present invention thus has application in private industry, personal and government arenas, to include credit exchange, personal, corporate and government security considerations. For instance, identification techniques in accordance with the present invention may be used to verify the authenticity of purchasers for credit, airline pilots and passengers, as well as that of corporate and military personnel accessing confidential information. Access to equipment may also be controlled with the present invention.

Prior to approval of the transaction, the user may have an opportunity to review transactional data relating to the pending transaction, such as pricing information. Such precaution further mitigates incidents of erroneous transactions by requiring the user to both access the identifying device and affirmatively approve the particulars of the transaction with remote identifying data. Similarly, a corporate representative or parent may verify and approve a pending transaction initiated by an employee or child, respectively. Such control may be automatically instituted using a profile.

Profiles may be used to further safeguard and streamline electronic transactions. A profile may contain programmatic rules of operation that stipulate how, when and where transaction verification processes are to be accomplished. For instance, a profile may designate a secondary identifying device to be used when a primary identifying device is unresponsive. Certain types and times of transactions may receive additional scrutiny, and a profile may initiate disapproval of a particular transaction based on a predetermined condition and irrespective of matching data.

By virtue of the foregoing, there is thus provided an improved mechanism for determining whether an electronic transaction is authorized to proceed that addresses above-identified shortcomings of known authentication and commercial transaction systems. These and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1 is a block diagram of an embodiment of an authentication system in accordance with the principles of the present invention for determining whether an electronic transaction should proceed.

FIG. 2 is a block diagram of a second embodiment of an authentication system in accordance with the principles of the present invention for verifying that an electronic transaction should proceed.

FIG. 3 is a block diagram of an authentication system for determining whether a user seeking to operate a vehicle should be granted access to the vehicle in accordance with the principles of the present invention.

FIG. 4 is a flowchart having method steps suitable for execution by a processing system of the system of FIG. 1.

FIG. 5 is a flowchart having method steps suitable for execution by a user of the authentication system of FIG. 1.

FIG. 6 is a flowchart outlining method steps for generating a profile of the authentication system of FIG. 1.

### DETAILED DESCRIPTION OF THE DRAWINGS

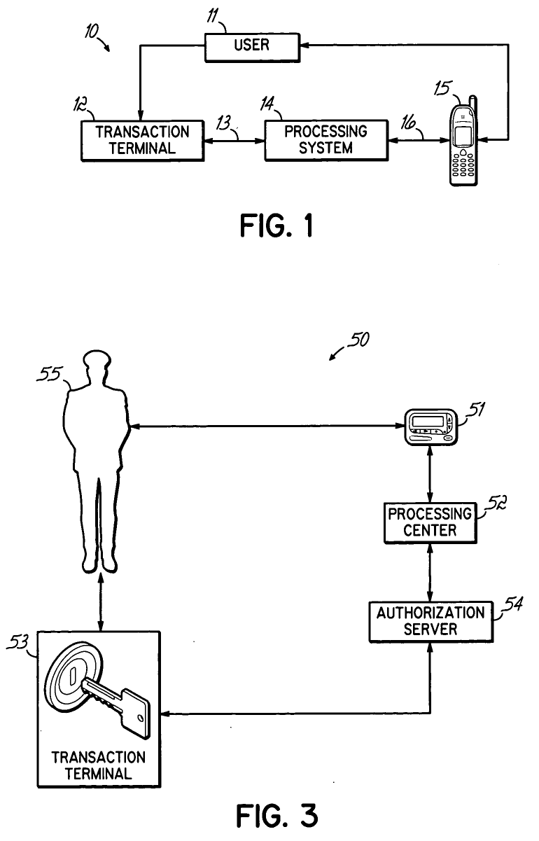

FIG. 1 is a simple block diagram of an authentication system 10 for determining if an electronic transaction, such as a merchandise purchase, is authorized and should proceed. When a user 11 attempts to make a purchase on credit, they typically provide a credit card to a vendor operating a swipe machine, register, or other transaction terminal 12. Information from the card is read off of the card by the swipe machine, for instance, and is communicated over a communications link 13 or network to a processing system 14. The processing system 14 evaluates the information, usually along with a conveyed purchase amount, to see if the information corresponds to a valid account and the purchase amount is within acceptable limits. Assuming this is the case, the processing center 14 will conventionally send approval to the transaction terminal 12 at the vendor site, so that the sale may complete, receipts may be generated and the transaction may otherwise proceed as normal.

Processes of the present invention interrupt conventional approval practices by holding back authorization sent from the processing system 14 to the vendor until an authorized user verifies the transaction using their cellular phone 15. That is, the processing system 14 communicates with the cellular phone 15 to retrieve a password, token, or BIR from the authorized user. To this end, the processing system 14 may maintain a list of cellular phone numbers associated with authorized user(s). Thus, the authorized user may be automatically contacted via the cellular phone 15 or other identifying device that would normally be in the possession of or otherwise accessible to that person. When contacted, the transaction can be verified or refused using the cellular phone 15 by the rightful owner or authorized user. The system thus significantly reduces the risk of fraud or error.

More particularly, a user 11 may attempt to purchase merchandise, for example, at the transaction terminal 12. The transaction terminal 12 contacts the processing system 14 in response to the user initiating the transaction at the terminal 12. The processing system 14 then contacts the authorized user 11 via the cellular phone 15. Namely, the processing system 14 dials the number of the cellular phone 15, causing it to ring. If the user has the cellular phone 15 on their person, the user 11 may be prompted to depress a sequence of buttons on the phone 15 or speak a particular phrase that comprises remote identification data. That is, after reviewing data presented by the cellular phone 15 that describes the pending transaction, the user 11 either approves or disapproves of the pending transaction by inputting remote identification data into the cellular phone 15. Such data may include token, password or biometric features where desired. The cellular phone 15 communicates the remote identification data back to the processing system 14, which in turn, compares the remote identification data to stored data to see if a match (within predetermined limits, if biometric) can be determined. If so, the processing system 14 may send authorization back to the transaction terminal 12. Otherwise, the processing system 14 may communicate disapproval back to the terminal 12 using conventional processes.

The cellular phone 15 has features, such as a transmitter, receiver and keypad that are well suited for communicating data between a user and a processing system 14. The proliferation of cellular devices also makes its application in the context of the present invention very practical. However, while the identifying device of FIG. 1 may embody a cellular phone, another identifying device may comprise one or more of many devices configured to transmit and receive signals to and from a processing system 14. As such, typical identifying devices may include a pager, a personal digital assistant (PDA) and/or a laptop computer, among other devices. Such devices are typically strongly associated with the user, i.e., carried on the person of the user. As such, identifying devices commonly include devices that would be statistically unlikely for an unauthorized user to access.

As shown in the system 10 of FIG. 1, the cellular phone 15 transmits and receives signals to and from a processing system 14 over link 16. For the purposes of the invention, the processing system 14 may represent most types of controllers, computer systems, processors or other programmable electronic devices capable of functioning as a processor, client and/or server computer. Where desired, the processing system 14 may be implemented using one or more networked computers or other controllers, e.g., in a cluster or other distributed computing system.

The processing system 14 typically communicates directly or indirectly with a transaction terminal 12. A typical transaction terminal 12 includes a card slot reader at a vendor's, or a computer used to make an online purchase. However, aspects of the present invention may also apply to mechanical devices. For instance, a transaction terminal may include an ignition switch, among other mechanisms configured generally to receive a token and/or other identification associated with a user account. For purposes of this specification, an account includes one or more records pertaining to a user or group of users.

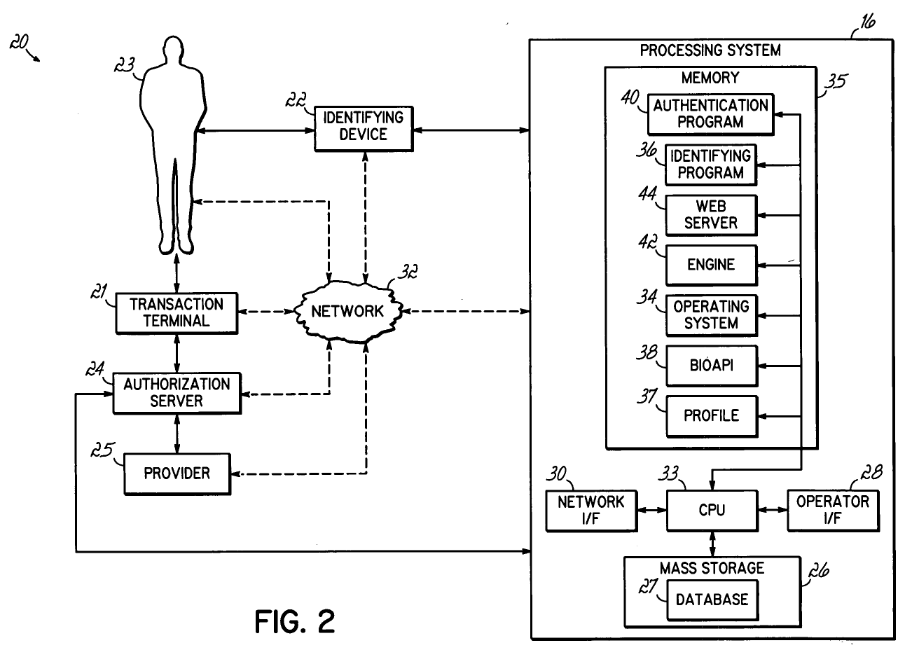

FIG. 2 shows an authentication system 20 that includes an identifying device 22 that receives remote identification data of a user 23. While the identifying device 22 may embody the cellular phone shown in FIG. 1, a suitable identifying device 22 may comprise most devices configured to transmit and receive signals to and from a processing system 16. The processing system 16, in turn, may communicate with an authorization server 24. Where so configured, the authorization server 24 is in communication with both a credit/data provider 25 and a transaction terminal 21. The transaction terminal 21 generally receives input originating from the user 23 and/or a merchant.

System 20 includes at least one apparatus, e.g., one or more computers, such as the processing system 16. For the purposes of the invention, the processing system 16, as with most other devices or system components included in this specification and termed a “computer, “controller” or “processor,” may represent practically any type of controller, computer system, processor or other programmable electronic device capable of functioning as a processor, client and/or server. Where desired, the processing system 16 may be implemented using one or more networked computers or other controllers, e.g., in a cluster or other distributed computing system.

Processing system 16 typically includes a central processing unit 33 comprising at least one microprocessor coupled to a memory 35, which may represent the random access memory (RAM) devices comprising the main storage of processing system 16, as well as any supplemental levels of memory, e.g., cache memories, non-volatile or backup memories (e.g., programmable or flash memories), read-only memories, etc. In addition, memory 35 may be considered to include memory storage physically located elsewhere in processing system 16, e.g., any cache memory in a processor in computer processor unit (CPU) 33, as well as any storage capacity used as a virtual memory, e.g., as stored on a mass storage device 26 or on another computer coupled to/in communication with processing system 16.

Processing system 16 also typically receives a number of inputs and outputs for communicating information externally. For interface with an operator, processing system 16 typically includes an interface 28 incorporating one or more input devices. Otherwise, operator input may be received via another computer or terminal.

For additional storage, processing system 16 may also include one or more mass storage devices 26, e.g., a floppy or other removable disk drive, a hard disk drive, a direct access storage device (DASD), an optical drive (e.g., a CD drive, a DVD drive, etc.), and/or a tape drive, among others. Furthermore, processing system 16 may include an interface 30 with one or more networks (e.g., a LAN, a WAN, a wireless network, and/or the Internet, among others) to permit the communication of information with other computers and electronic devices. It should be appreciated that processing system 16 typically includes suitable analog and/or digital interfaces between CPU 33 and each of components 26-44, as is well known in the art.

Processing system 16 may be implemented using a multi-user computer such as a server computer, a midrange computer, a mainframe, etc. The identifying device 22 may also be implemented using a desktop, single-user computer or any other device having a processor and configured to transmit and receive signals to and from, for example, the processing system 16. As a result, the specifications of the CPU's, memories, mass storage, user interfaces and network interfaces will typically vary as between the processing system 16 and identifying device 22. One skilled in the art should additionally appreciate that other hardware environments are contemplated within the context of the invention.

Where direct, dedicated connections are not preferred or practical, processing system 16 generally interfaces with the authorization server 24 and/or identifying device 22 via a network 32. The network 32 may be public and/or private, wired and/or wireless, local and/or wide-area, etc. Moreover, the network 32 may represent multiple, interconnected networks. As shown in FIG. 2, for example, network 32 may include the Internet.

The processing system 16 operates under the control of an operating system 34, and executes or otherwise relies upon various computer software applications, components, programs, objects, modules, data structures, etc. (e.g., identifying program 36, BioAPI 38 and biometric authentication program 40, among others. BioAPI 38 regards a programming interface supplied by biometric service providers that provides enrollment and verification services for installed biometric devices). Moreover, various applications, components, programs, objects, modules, etc. may also execute on one or more processors in another computer coupled to processing system 16 via a network, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer and/or network of computers, and that, when read and executed by one or more processors in a computer or other device, cause that computer/device to perform the steps necessary to execute steps or elements embodying the various aspects of the invention.

While the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the virtually endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, embodiments consistent with the invention may be configured to authenticate people using applets and other such layers of software via an active hypertext document. As is well known in the art, applets may be used to generate active hypertext documents through which input data may be supplied for subsequent transmission. As discussed herein, identifying operations may be implemented by embedding one or more instructions within the active hypertext document to initiate the performance of the authentication by the processing system 16.

One or more applets may be configured for execution by an engine 42 resident on the processing system 16. The engine 42 may process the applets to generate one or more active hypertext documents for transmission by a web server 44 that also resides on the processing system 16. Such active hypertext documents may be downloaded to remote devices/computers. In one embodiment, such active hypertext documents may be processed by a web browser, which renders the documents on a client display at the authentication server 24 or identifying device 22 in a manner well known in the art. Processing system 16 also typically receives a number of inputs and outputs for communicating information externally. As discussed herein, processing system 16 typically includes an interface for communication with the identifying device 22 and the authentication server 24.

As discussed herein, the authentication server 24 may include a networked computer similar to the processing system 16. For instance, the authentication server 24 may include a CPU, memory, interface, browser and other similar programming. However, one of skill in the art will appreciate that the hardware and software of the authentication server 24 may vary substantially from that of the processing system 16 per application specifications. In the context of an electronic transaction, a typical authentication server 24 likely comprises one or more servers in communication with merchants and creditors.

The authentication server 24 may include software configured to route transactional data between a vendor's transaction terminal 21 and the electronic systems of the provider 25 and/or the processing system 16. For purposes of this specification, the transaction terminal 21 may comprise a card slot, Internet text field or most other mechanisms configured to receive account information or other electronic input. Transactional data may include transactional information from the merchant, such as pricing and vendor locator data. Data from the processing system 16 may include approval of the credit request or other transaction.

The identifying device 22 is preferably strongly personal to the user 23. That is, the user 23 typically has a type of access to the identifying device 22 that would be statistically unlikely for an unauthorized user to achieve. For instance, the identifying device 22 of one embodiment may be portable, and thus carried on or near the person of the user 23. Identifying devices 22 may include a cellular phone, a pager, a personal digital assistant (PDA) or a laptop computer, among others.

The identifying device 22 is typically accessible to the user 23 at the time of a transaction. Additionally, the identifying device 22 is usually under the personal and/or exclusive control of the user 23 and/or their assigns. A user 23 for purposes of this specification may thus comprise a single person or a collection of authorized users per application specifications.

The portable and ubiquitous nature of cellular phones, pagers and other types of identifying devices furthers their practicality in some verification applications. However, one skilled in the art will appreciate that an identifying device 22 may comprise virtually any device configured to transmit and receive a signal, to include devices that are dedicated and/or stationary, as well as a device having no function outside of the identification processes of the present invention. That is, a suitable identifying device may be constructed to communicate only between the user and the processing system 16, for example. However, where desired for economy considerations, devices commonly having application independent from transaction verification may be augmented with programming in accordance with the principles of the present invention. Moreover, such conventional devices may additionally be augmented with features that advance identification. Such features may include a BIR interface, such as a fingerprint reader and/or a voice recognition program associated with a cellular telephone.

The identifying device 22 typically receives a number of inputs and outputs for communicating information externally. For interface with the user 23 and the processing system 16, the identifying device 22 typically includes an interface incorporating one or more user input devices (e.g., a keyboard, a mouse, a trackball, a joystick, a touch pad, smart card slot, retinal/fingerprint scanner, smart card/key, token detector and/or a microphone, among others) and a display (e.g., a CRT monitor, an LCD display panel, and/or a speaker, among others).

One skilled in the art will appreciate that most of the components 20-44 of FIG. 2 may be omitted and/or augmented in accordance with the principles of the present invention per application requirements. Moreover, the processes of one or more of the components 20-44 may be integrated with another component for application considerations. For instance, the account server 24 may include or otherwise incorporation functionality of the provider 25. Moreover, the functionality of the account server 24 may be included within the processing system 16. Furthermore, while shown with direct communication channels denoted by solid lines, one of skill in the art will appreciate that one or more of the components 20-44 of the processing system 16 may interconnect with the identifying device 22 using Internet or other network 32 connections. FIG. 2 shows networked connections in phantom.

Those skilled in the art will recognize that the environments illustrated in FIGS. 1 and 2 are not intended to limit the present invention. Indeed, those skilled in the art will recognize that other alternative hardware and/or software environments may be used without departing from the scope of the invention. One such environment is illustrated in FIG. 3.

More particularly, while a typical transaction terminal comprises a card reader of a vender, aspects of the invention also apply to machine transactions and associated hardware. For instance, a transaction may include starting a vehicle. In such a scenario, the mere insertion of a key into an ignition block does not enable the user to start the vehicle. Such ignition is only realized when the transaction is authorized using remote identification data of the user.

More particularly, the block diagram of FIG. 3 shows a system 50 for authenticating the identity of a plain or automobile operator 55. In terms analogous to those of FIG. 2, the driver/pilot comprises a vehicle operator desiring authorization to initiate processes at a transaction terminal that includes an ignition switch 53. That is, the operator 55 wants to start the vehicle using the switch 53. In on scenario, the operator may begin an ignition sequence by inserting a key into the switch 53. In response to the ignition sequence at the switch 53 (e.g. key insertion), an authorization server 54 in communication with the ignition switch 53 directs a request for verification to a processing center 52. The processing center 52, in turn, generates and sends a request for remote identification data to an identifying device 51 that is accessible to the operator 55.

The operator 55 enters remote identification data into the identifying device 51, which routes the remote identification data to the processing center 52. The processing center 52 compares the remote identification data to stored identifying data associated with the user 55. The comparison reveals whether the person purporting to be the pilot/driver 55 is, in fact, the driver/pilot authorized to operate the vehicle. A transaction involving the authentication system 50 may conclude with the processing center 52 enabling activation of the ignition switch 53.

In another application of the invention, the processing center 52 may be collocated with the transaction terminal 53. For example, processing center circuitry housed within an ignition block may transmit a request for remote identification data to an identifying device 51 of the operator in response to insertion of a key. For additional security, transmission of the request may have a limited range, requiring the identifying device 51 to be in close proximity to the transaction terminal.

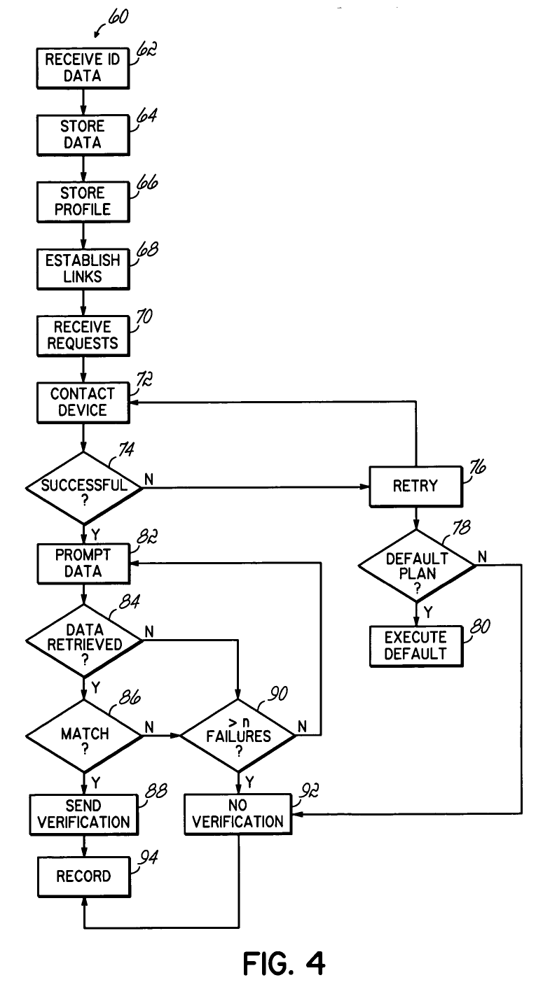

The flowchart 60 of FIG. 4 shows sequence steps suitable for execution within the hardware and software environments of FIGS. 1-4. That is, FIG. 4 includes method steps for verifying the authenticity of an electronic transaction. In one sense, the steps may further authenticate the identity of a user 23 who desires access to credit or secured data. Moreover, the steps show transactional processes executed by the processing system 14 of FIG. 1.

Prior to an electronic transaction, the processing system 16 receives an initial submission of identifying data from the user 23 at block 62. For instance, the user 23 may provide a password, token and/or a BIR to a service subscribing to, supporting or otherwise maintaining the processing system 16. The processing system 16 may store the initial submission of identifying data at block 64 for future use. Namely, the processing system 16 uses the stored identifying data to verify captured identifying data, which is subsequently presented to the processing system 16 via the identifying device 22.

Also prior to the transaction, the processing system 16 may generate and store user/system profiles 37 at block 66. While discussed below in greater detail, such profiles 37 may include rules regulating processing system 16 actions given certain operating parameters. For instance, a profile 37 may affect the functions of the processing system 16 regarding when, where and how the remote identification data is captured from the user 23. Another preliminary step at block 68 may include establishing or ensuring the vitality of communication links between the processing system 16 and the authentication server 24, as well as to the identifying device(s) 22 that may be designated in a profile 37. In many commercial applications, the processing system 16 maintains links for a plurality of identifying devices and for a number of different users.

In operation, the processing system 16 receives a request for verification at block 70. The authentication request may arrive from the authentication server 24, or directly from the transaction terminal 21. The request for verification from the authorization server 24 may be in response to a merchant sending a transaction request to the authorization server 24 via the transaction terminal 21. For instance, the user 23 may initiate a purchase for an airline ticket using conventional credit mechanisms, e.g., the terminal 21. The terminal 21 may prompt the authorization server 24 to create a verification request to the processing system 16. As such, processes consistent with embodiments of the present invention may compliment and augment some existing transaction systems, contributing dramatically to vendor, creditor/provider, user, and in the present instance, airline security without requiring major merchant capital expenditures on new equipment.

In response to the request, the processing system 16 attempts to contact the identifying device 22 at block 72. Namely, the processing system 16 sends at block 72 a request for remote identification to the identifying device 22. The mechanism for delivery of the request for remote identification may depend in part upon the predetermined profile 37 of the user 23, as well as considerations regarding the hardware and programming inherent to the identifying device 22 utilized. For example, an identifying device 22 comprising a cellular telephone may receive the request for remote identification as routed from conventional cellular towers. An authentication device program may receive the request for remote identification via an internal or networked computer system connection.

Where so prescribed in a profile 37 associated with the user 23 and/or the system 10, the processing system 16 will respond to an unsuccessful attempt at block 74 by contacting the identifying device 22 with one or more subsequent attempts at block 76. The determination of a predetermined default plan at block 78 will initiate execution of that plan at block 80. Otherwise, the processing system 16 may end the transaction at block 92 by sending an appropriate notification back to the authentication server 24.

Assuming the processing system 16 succeeds in making contact with the identifying device 22 at block 72, the user 23 may be prompted at block 82 to provide remote identification data to the identifying device 22. For instance, the user 23 may be presented with a biometric interface configured to guide them through a process of submitting a live, or capture, BIR. More particularly, an automatic voice prompt on a telephone of a user 23 may ask the user 23 to speak a predetermined phrase if they desire the transaction to complete. Conversely, the phrase may be spoken where the user 23 does not wish the transaction to complete. Such a scenario may exist where the system 20 is set up to confirm that a transaction not be approved.

To this end, appropriate software may launch a preferred biometric test at the identifying device 22 according to the preset parameters of a biometric verification sequence. A sequence may include a displayed user interface screen configured to cause the user to provide the voice or other capture remote identification data. For example, a fingerprint authentication application may prompt the user, “Place finger on scanner to approve the transaction.” To this end, the request for remote identification may include pricing, merchant and other transactional information relating to the pending transaction. Where desired, a prompt of the identifying device 22 may include a flashing light, audible alarm, vibration mechanism, or virtually any other feature configured to alert the user 23 of the communication from the processing system 16.

The processing system 16 may receive from the identifying device 22 the remote identification data at block 84. Where desired, the remote identification data may be retrieved from memory of the identifying device 22. Such may be the case where a user 23 has only recently submitted a capture BIR for the same or a different application. Where so configured, the program code 42 may download the recently stored capture BIR for submission to the processing system 16. Thus, one embodiment of the invention does not require the user to resubmit a capture BIR to realize remote identification.

Where the processing system 16 fails to receive the remote identification data from the user 23 at block 84 within a predetermined amount of time, the processing system 16 may initiate an action to end the pending transaction at block 92. A similar action may be taken where a user 23 sends an active command back to the processing system 16 disaffirming the pending transaction. In either case, such precaution helps to prevent transactions unwanted by an account holder by requiring the user 23 to both access the identifying device 22 and to affirmatively approve the transaction with remote identification data.

Remote identification data received from the user 23 at block 84 may be evaluated at block 86 to determine if it sufficiently matches the authentication data stored at block 64. Where such a match is determined at block 86, the processing system 16 may communicate verification to the account server 24 at block 88. Conversely, a determined failed match at block 90 may initiate another submission of remote identification data from the user 23 back at block 82. Depending on the profile 37 of the user 23 and/or system 10, a failed match may alternatively end a pending transaction at block 92 by sending a denial signal to the merchant via the authentication server 24. Again per the applicable profile 37, the processing system 16 may notify the user 23, provider 25 and/or account server 24 of the transaction status. In either case, pertinent details of successful and unsuccessful transactions may be recorded at block 94.

As with the all of the figures discussed below, most any of the steps associated with FIG. 4 may be omitted, rearranged or augmented with additional steps in accordance with the principles of the present invention. Such changes merely constitute additional embodiments of the invention as suited to different operating environments and specifications. For instance, the remote identification data comparisons of blocks 84-86 of FIG. 4 may be accomplished apart from the processing system 16 in certain embodiments of the invention. Furthermore, a match determination may alternatively occur at the identifying device 22 of the user 23. As such, the processing system 16 may alternatively receive the results of the determination from the identifying device 22, and communicate those results as before at block 88 or 92.

Moreover, multiple devices 22 may be contacted at block 72, either in sequence or, effectively, simultaneously. In that case, the first device answered is used for purposes of the sequenced steps of FIG. 4. Such a scheme may be advantageous where a user 23 has both a cellular phone and a pager designated as their identifying device, but may only have one of them on their person at the time of a transaction.

According to another aspect of the invention, the authentication request of block 70 may be designated according to its urgency. For example, a request to authorize a purchase while a user 23 waits at a transaction terminal 21 may be programmatically designated as “priority.” As such, the priority designation may ensure that there is no unreasonable in delay in conducting the entirety of the transaction. That is, the appropriate identifying device 22 is promptly contacted at block 72, and/or the user is timely prompted for identification data at block 82. Moreover, the relatively urgent nature of the priority designation may require that the user 23 submit the requisite approval data within a relatively short response time in order for the transaction to proceed. For example, the user 23 may be limited to a five minute period of time in which to submit the data. Such a predetermined transaction time period may commence when the user is first prompted for the data or in response to some other specified occurrence.

If the data is not submitted within the timeframe, irrespective of its authenticity, the transaction may fail. Conversely, a lower priority request may allow the user 23 a number of hours, days or even or longer to respond to a prompt at block 82. The prompt at block 82 may even be delayed, where appropriate. Such longer response times may have particular application where an item is ready to ship, pending approval by the user 23 within the response time. For instance, a user 23 not having access to their identifying device 22 at the time of a prompt may nonetheless permit the purchase to proceed online or by phone, but the transaction may not proceed until the user 23 has returned home or otherwise regained access to the device 22. Where so desired, a user 23 who does not respond within a first transaction time period may be given a subsequent period, not necessarily contiguous with the first, in which to respond in order to authorize the transaction. The present invention thus covers both realtime and delayed verification scenarios.

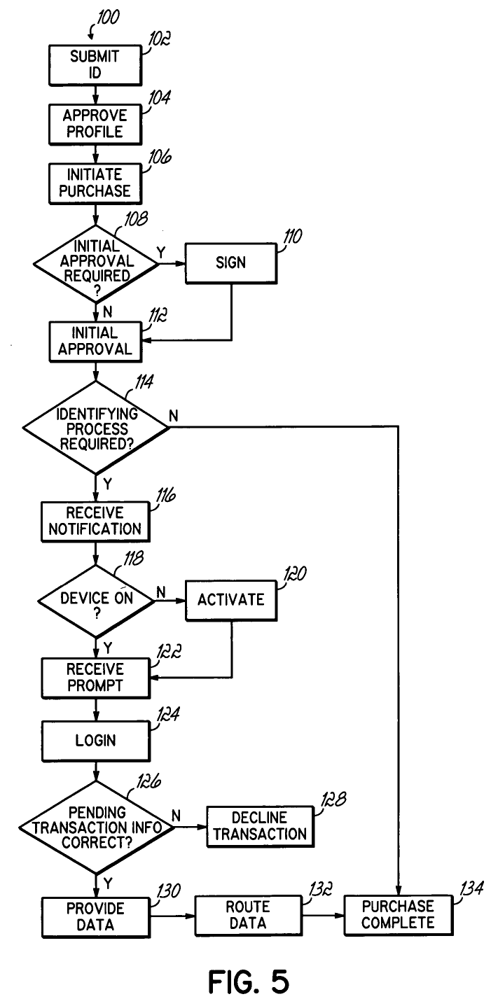

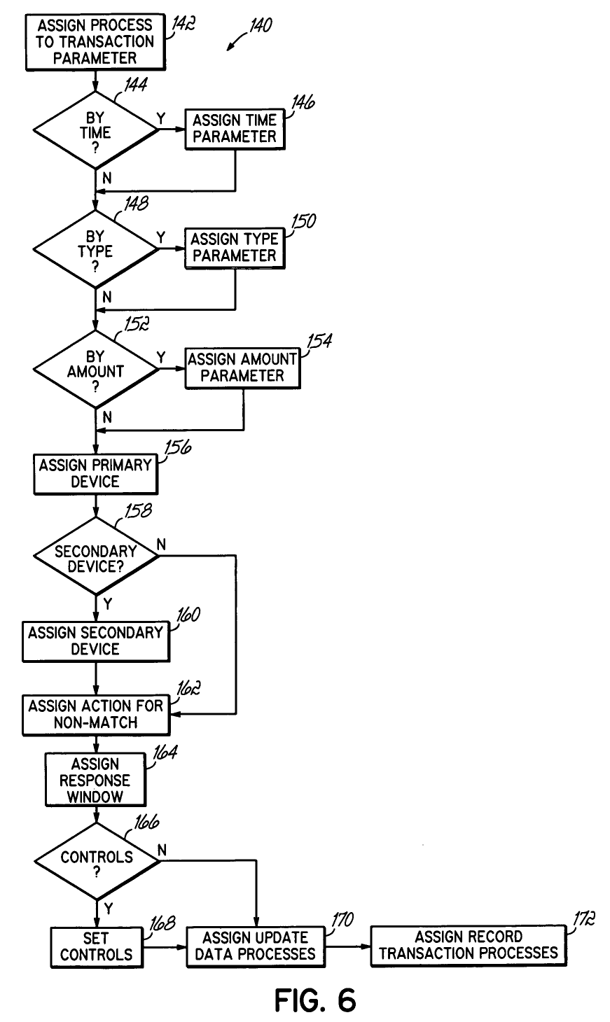

The flowchart 100 of FIG. 5 shows steps taken by the user 23 of FIG. 2 in accordance with the principles of the present invention. A user 23 may include one or more persons authorized for and/or attempting to access credit, information, equipment and/or services controlled by an (account) provider 25. The user 23 is typically registered prior to a transaction sequence, however, an initial transaction may include enrollment processes where appropriate. In either case, the user 23 may submit identifying data to the processing system 16 at block 102. Such identifying data may be stored in accordance with many conventional enrollment practices. The identifying data may include the type of data that can be subsequently repeated using their designated, identifying device(s) 22. For instance, a user 23 may use a number or text pad to key in a password into their pager or palm pilot.

Where desired, a person whose authentication data is stored in connection with one creditor, account and/or operating system may enroll in a different application without having to accomplish conventional enrollment processes for that particular processing system or provider. The enrollment credential of the first application is automatically transferred to the second application as the new or updated enrollment credential for the second application. Such a process may save time for users, among other benefits. The general process of promoting enrollment identifying data is disclosed in International Application No. PCT/US02/29166, which was filed on Sep. 13, 2002, is entitled “Credential Promotion,” and is hereby incorporated by reference in its entirety.

Where required or desired, the user 23 may establish a profile 37 at block 104. While discussed below as the subject of FIG. 6, a profile 37 for purposes of FIG. 5 may include one or more rules affecting operation of a transaction's verification, to include the user's authentication. Such operating rules may dictate, for instance, which identifying devices 22 and/or types of remote identification data are to be used. While some such profiles 37 may include user preferences, other types of data comprising a profile 37 may include system level mandates. One such system profile attribute may stipulate the duration of an allotted window of time in which the user 23 must respond to a request for remote identification before a transaction becomes abandoned.

Blocks 102-104 specifically show processes that regard establishing a user 23 within an authentication system 10. One of skill in the art will recognize that additional steps may be required and added in accordance with the underlying principles of the present invention, as such processes are widely known in the context of existing program enrollment.

As shown in FIG. 5, the user 23 initiates a transaction at block 106. For example, the user 23 may communicate a desire to purchase an item to a merchant. In so doing, the user 23 may provide a form of account identification to the merchant. Such identification may comprise a conventional credit card, an account number, as well as a token created for the purpose of identifying the user 23. The identification may be received at a transaction terminal 21. While described above in a commercial vending scenario, a transaction terminal 21 for purposes of this specification may comprise a card slot reader, a networked computer, a signal receiver or an ignition switch, among other mechanisms configured generally to receive data relating to an account of the user 23.

Where so configured, the submitted identification may undergo initial scrutiny at blocks 108-112 of FIG. 5. Such scrutiny may include processes similar to that described above in the context of conventional credit cards. That is, the processing system 16 may initially verify that an account exists for the proffered account. Another conventional initial verification may include presenting a signature for evaluation by the merchant at block 110 for initial screening/approval at block 112. Due to the improved authentication processes of the present invention, these initial evaluation steps of blocks 108-112 may be scaled down or altogether omitted in certain applications. Where such evaluation is deemed unnecessary, for instance, then the processes of transaction may begin directly at block 114.

Just as the inclusion or omission of blocks 108-110 may be determined by the profile 37 of block 104, so may application of the identifying processes at block 114. That is, the user 23 or system 20 may have the option via the profile 37 to selectively determine whether to further activate transaction authentication processes. For instance, certain processes of the system 20 may only activate for purchase requests exceeding some preset monetary amount. That amount may be designated via a profile 37. In one embodiment, a user 23 may disable the system 20 using a button or switch on their identifying device 22. Such action may result in an otherwise conventional transaction. The same action in another scenario may halt further transactions.

Where identifying processes in accordance with the principles of the present invention are desired and active at block 114 of FIG. 5, the user 23 may be informed by the vendor at block 116 that secondary, identifying will be accomplished. Such notification may remind a user 23 to activate their identifying device 22 at block 118, if not already powered.

The user 23 receives a request for remote identification at their identifying device 22 at block 122. For example, the user 23 may receive a call on their cellular telephone instructing them to speak a password. The spoken password may comprise the remote identification data, as ascertained by voice recognition and/or biometric software. Prior to providing the remote identification data, certain embodiments of the present invention may require the user to log into the identifying device 22 at block 124. For example, the remote identification feature of a cellular phone or other identifying device 22 may be password or BIR protected. In one embodiment, a user 23 may be required to enter the password (or BIR, where appropriate) prior to activating the identifying device 22 and responding to the request for remote data at block 122.

A user 23 may confirm the particulars of a pending transaction using the request for remote identification. For instance, a prompt on a pager at block 524 of FIG. 5 may display text, “Enter code if you wish to approve $400 for groceries.” Confirmation of such pricing and other information at block 126 prior to authorization may thus provide an additional measure of security. For instance, where the reported pricing information is in error, the user 23 may effectively cancel or delay the transaction. The discrepancy may thus be addressed with the merchant at block 128 before the user's account is credited. Where the user 23 alternatively desires to approve the expenditure at block 524, the remote identification data is provided to the identifying device 22 by the user 23 at block 130. The user 23 at block 130 has then completed all steps necessary to realize the transaction at blocks 132 and 134.

The flowchart 140 of FIG. 6 shows steps suited to generate a profile 37 in accordance with the principles of the present invention. As discussed herein, a profile 37 generally regards a set of system 20 and/or user 23 stipulated rules that affect operation of transaction verification. Profiles 37 may be established prior to an electronic transaction to add an additional degree of security and convenience, as well as to streamline authorizations and/or transactions.

At block 142, the user 23 and/or a system administrator may determine for which type of transactions the processes of the present invention will activate. For instance, there may be certain types of “low risk” transactions for which the user 23 may not desire identification processes. For instance, a profile 37 may not initiate verification processes for historically regular or otherwise designated types of purchases. Another profile 37 attribute may be directed to the time of day that a transaction occurs. For example, the user 23 may wish at block 144 to have any purchase occurring after eight o'clock p.m. to be personally authenticated using transaction verification processes. As such, the profile 37 may be augmented to reflect the designated time at block 146.

Similarly, a user 23 or system administrator may desire at block 148 to have only Internet purchases verified using the transaction verification processes. The profile 37 of another or the same embodiment may require verification processes for any purchase of over fifty dollars. The determined type of transaction at block may further dictate the type and quantity of remote identification data required for authentication. For instance, a profile set up by an employer may require that each purchase above a limit made using a corporate credit card be authenticated using at least two of a password and a voice and/or fingerprint. While such settings may be readily accomplished at blocks 148-154 of FIG. 6, it should be appreciated by one of skill in the art that virtually any quantifiable metric regarding a transaction may be additionally used to screen or initiate authentication processes that are in accordance with the present invention.

Profiles 37 may also stipulate a preference for the identifying device 22 to be used in the transaction. For example, a user 23 may programmatically designate a cellular telephone as being their primary identifying device 22 at block 156. Where desired, the user 23 may also designate secondary, or back-up, devices at blocks 158-160. However, it should be appreciated that secondary devices 22 within the same embodiment may actually act as primary identifying devices 22 under certain conditions. For example, a profile 37 may stipulate that transactions used to start an automobile use a receiver on a key chain as an identifying device 51, while all other transactions use a pager, instead.

The profile 37 of one embodiment may additionally employ multiple identifying devices 22 in a single transaction. For instance, a user 23 may have to submit a fingerprint to a cell phone, as well as type a password into a PDA. Another or the same profile allows a user 23 or administrator of the user's account to select the identifying device(s) and/or the type of remote identification data used in a transaction. For example, the cellular phone of a user may prompt, “Do you want to confirm the transaction using your voice signature or your password?” Another prompt, “Please don't ask me again,” may save the settings selected by the user or administrator.

While such preferences may be programmed into a given profile 37 by the user 23, profiles 37 of other or the same embodiments may include system level preferences. Such system level preferences may reflect a policy intended to affect all or a designated number of users 23 serviced by a processing system 16, for instance. Thus, a system preference may apply to a network, a subsystem/cluster, or a group of user accounts. By virtue of this feature, an account manager or other administrator can designate groupings of users having the particular security requirements mandated by the system policy. Tags relating to these requirements or settings may be programmatically attached to a database field associated with the designated users 23 and maintained at the authorization server 24 or processing system 16. A transaction may then initiate access of these database fields to determine the appropriate identifying device(s) 22.

A preference affecting system policy in one embodiment may include a confidence rating. A confidence rating may be assigned by an administrator in view of reliability and security considerations of different types of identifying devices 22 and/or remote identification data. Confidence ratings may be assigned to, for instance, an identifying device 22 and/or a specific type of an authentication transaction. In operation, an administrator may assign a higher confidence rating to an identifying device 22 having security standards known to be higher than those of a more easily compromised, secondary device.

As such, the system 20 may select a most appropriate identifying device 22 having the higher confidence rating to use in a given transaction. For example, the program code 40 may select a telephone accommodating a fingerprint BIR over a smart card reader. Yet another suitable profile 37 instituted by a system administrator may include random device selection features.

In an effort to automatically determine an appropriate identifying device 22, the system 20 may make an accounting of which biometric or other authentication devices are currently assigned to a user 23 and/or installed on a given identifying device 22. For instance, a local computer 102 of the user may be equipped with both fingerprint and retinal biometric testing devices. Proprietary programs associated with conventional biometric testing devices (including BioAPI code 38) place a marker within a registry of the laptop 102 or other identifying device 22 upon installation and de-installation. This registry provides a mechanism for the system 20 to assess available devices 22. Another or the same embodiment may rely on processes that enumerate available devices in real time, or at the time of transcription, thus providing the system 20 with an accounting of appropriate devices.

The profile preferences discussed herein in the context of driving an authentication selection process are included only for exemplary purposes. Accordingly, preferences may be omitted, altered and supplanted with others in accordance with the principles of the present invention. While some such preferences may be discriminating, others may simply sequence through an entire list of retrieved devices before finding one that is compatible with subsequently implemented policies. In any case, any number of alternative programs configured to suit the specific needs of the network system 20 may be used to determine an identifying device 22 from which to retrieve remote identification data.

The profile 37 may be programmed with instructions at block 162 that specifies actions to be taken by the processing system 16 in the absence of a match of the captured and stored authentication data. Such actions may include a specified number of reattempted matches, designated secondary devices, as well as the denial of a transaction. The system 10 at block 164 may further include information within the same profile 37 that stipulates the period, or window, of time within which a user 23 must respond to a request for remote identification in order to avoid abandonment of the electronic transaction.

At blocks 166-168 of FIG. 6, the profile 37 may be programmed with controls intended to prohibit or channel specified transactions. For example, such controls may be used by parents or authorized officials to prevent juveniles from accessing websites hosting objectionable content. Other controls may halt commercial credit transactions deviating from a preset budget of the user 23, irrespective of their actual credit limit. Still another profile 37 may act to prevent vehicular offenders from accessing an automobile during certain hours.

A user 23 or system administrator may account for BIR update procedures and activity logs at blocks 170 and 172 of FIG. 6, respectively. For instance, a suitable BIR update may include storing remote identification data in the place of previously stored BIR data as discussed above. Logged activity may include transactional and pricing data as desired for security and accountability purposes.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. For example, identifying data, remote identification data and other identifying information may be encrypted at any step delineated in the above-discussed flowcharts in accordance with the principles of the present invention.

Furthermore, multiple users may be allowed or required to participate in a single transaction verification sequence. For instance, a first user may initiate a transaction at terminal, while a second user is contacted via their own identifying device in response to the initiation of the transaction (by the first user). The second user may enter the remote identification data in response to the prompt, which is compared against the stored identifying data of the second user. The second user typically enters the remote identification data only after they have been given an opportunity to approve the particulars of a transaction. For example, a corporation, government office or parent may review and approve purchases made by an employee, civil servant, or teenager, respectively.

As such, the person or persons authorizing the transaction may not include the person attempting an actual purchase. For instance, an employee may attempt to make an expensive purchase on a corporate credit card. Per the applicable profile 37, the elevated cost may require transactional approval from both a manager and a corporate accountant. In another or the same instance, a supervisor may override the approval of another person who is otherwise authorized to verify a transaction. Still another profile 37 may require approval from some percentage or breakout of a group of authorized users. Where so configured, a processing center my concurrently or otherwise near simultaneously contact the respective identifying devices of multiple users who are all authorized to verify a transaction. As such, the first of the multiple users to answer their respective identifying device or submit the remote identification data may effectively control the outcome of the transaction verification. One skilled in the art will appreciate that a profile 37 for purposes of this specification may include nearly any conceivable rule or scheme, to include time-based, or sequential approvals where applicable. For instance, a first user may approve a transaction only after a first has given their own approval.

Where desirable, any number of delegates may be permitted to authorize a transaction as the authorized user. A delegate comprises a person or group of people having permission to enter their own remote identification data to authorize a transaction on behalf of the user having the account. Using remote identification data correlated to themselves, a delegate authorizes a transaction as the actual user.

For example, a spouse may initiate an online transaction at a transaction terminal comprising an Internet station kiosk at an airport. As a delegate, the spouse may enter identifying data unique to her husband's account. For example, the spouse may type into a computer field the number printed on the credit card of her husband. A request for verification generated in response to the activity at the kiosk is sent to a processing center. In one scenario, the processing center contacts all of the identifying devices assigned to the husband's account. Those identifying devices assigned to the account may include not only those associated with the husband, but also those assigned to persons designated as a delegate to the account, e.g., the spouse.

In the present case, the spouse is assigned to the account as a delegate. Records at the processing center show that the spouse (designated as a delegate) has specified her cellular phone as her primary identifying device. Where the identifying device of the husband is a pager, the processing center may communicate a request for remote identification data to both the cellular phone of the wife and the pager of her husband. The first of the spouses to answer their respective identifying device is then prompted to enter their remote identification data.

Should the wife answer her cellular phone first, for example, the identifying device prompts her to enter her personal, unique pin number to authorize the online transaction using her husband's account. The submitted remote identification data is matched against authentication data stored in association with the account at the processing center, for instance. The stored association may include a database comprising a list of delegates privileged to use the husband's account to verify transactions as the husband, himself. The database further includes stored authentication data for each delegate. As such, a match of the wife's pin to the stored pin associated with the wife (and as a delegate of her husband) enables authorization of the transaction just as if the husband, himself, had submitted his own remote identification data.

As an alternative to communicating a request for remote identification to the user and all assigned delegates, a delegate may designate their own personal identifying device at the time the transaction is initiated. For example, the wife in the above example may include in the identifying data submitted to the transaction terminal a delegate identifier, such as a pin code preceding the card number, that alerts the processing system as to the delegate status of the wife. As such, the processing system may contact only the identifying device of the delegate after processing the identifying data. The wife is then prompted to submit her remote identification data as before.

An analogous process of logging a delegate user into an account of a principal user as the principal is disclosed in International Publication No. WO 03/075135 A1, which was published on Sep. 12, 2003, is entitled “User Login Delegation,” and is hereby incorporated by reference in its entirety. As used therein, a “delegate user” is a “delegate” for purposes of this specification, and a “principle user” is referred to herein as “user.” Actions taken by the delegate while acting on behalf of the user may be recorded for evaluation and accountability considerations. Delegates privileged to privileged to act on behalf of the user are added and deleted to the database as necessary.

While embodiments discussed herein primarily involve the user 23 actively submitting remote identification data, other embodiments may passively acquire the remote identification data. For example, such data may comprise proximal information indicative of the user's position relative to a transaction terminal 21 or some other predetermined location. As such, a user may wear an identifying device 22 comprising a transmitter. The transmitter may further include a global positioning system (GPS) or other receiver configured to determine a position relative to a known location or transponder. Such a location may be communicated from the transaction terminal 21 along with the request for verification.

The processing system 16 may then compare stored identifying data comprising the location of the transaction terminal 21 against the remote identification data, which comprises the location of the GPS receiver/identifying device 22. When the GPS location communicated from the identifying device 22 matches within predetermined parameters the general coordinates/zip code of the transaction terminal 22, the processing system 16 sends verification back to the transaction terminal 22. This configuration thus imputes additional security into a transaction by virtue of requiring the identifying device 22 to be proximate the user 23/transaction terminal 22 for added security.

While a typical transaction begins with the presentation of identifying data at the transaction terminal 21, another transaction may include an initial step involving the identifying device 22 reading data from a bar code or port, for instance, of a transaction terminal 21. More particularly, a user may read or cause data to be entered into the identifying device 22 that may be used to identify a given transaction terminal 21 to the processing system 16. Such a scenario may be desirable where, for instance, a user 23 plans on making a purchase at the transaction terminal 21, but wished to avoid any delays associated with verifying the transaction while at the terminal 21. As such, this feature may allow a transaction to be pre-verified. That is, when the user 23 later initiates the purchase at the transaction terminal 21, the processing system 16 is effectively on notice, waiting for the request for verification to arrive from the transaction terminal 21.

When the request is received, the processing system 16 may send verification back to the transaction terminal 21 without first prompting the user 23 to enter remote identification data for approval. To this end, the data scanned, recalled from memory, read or otherwise received that identifies the transaction terminal 21 is communicated directly from the identifying device 22 to the processing system 16 along with remote identification data, for instance, prior to the user submitting identifying data at the transaction terminal. As such, the processing system 16 may already have the data needed to authorize or pre-approve the transaction before the user 23 presents the identifying data to the transaction terminal 21.

One of skill in the art will appreciate that the sequence of the steps in the included flowcharts may be altered, to include omitting certain processes without conflicting with the principles of the present invention. Similarly, related or known processes can be incorporated to complement those discussed herein. It should furthermore be understood that the embodiments and associated programs discussed above are compatible with most known enrollment processes and may further be optimized to realize even greater efficiencies. For instance, a program that locally stores BIR data in response to a successful login/enrollment may be complimented by features of the present invention. The general process of locally storing biometric data in response to a successful login is disclosed in International Application No. PCT/US01/30458, which was filed on Sep. 28, 2001, is entitled “Biometric Record Caching,” and is hereby incorporated by reference in its entirety. The invention in its broader aspects is, therefore, not limited to the specific details, representative apparatus and method, and illustrative examples shown and described. Accordingly, departures may be made from such details without departing from the spirit or scope of the general inventive concept.

1. A transaction verification method wherein a user has a user account with identifying data unique to that user account, the method comprising:
communicating identifying data unique to a user account to a transaction terminal to authorize a transaction for that user account;
communicating a request for verification of the user account to a processing system, the processing system including access to stored authentication data and to identifying devices for a plurality of user accounts;
communicating a request for remote identification data to an identifying device associated with the user account for which verification is requested; and
communicating verification to the transaction terminal if remote identification data is communicated from the identifying device which sufficiently matches the stored authentication data associated with the user account for which verification is requested.

2. The transaction verification method of claim 1, further comprising denying the transaction at the transaction terminal if the remote identification data does not sufficiently match the stored authentication data.

3. The transaction verification method of claim 1, further comprising executing a default action stipulated by a profile if the remote identification data does not sufficiently match the stored authentication data.

4. The transaction verification method of claim 1, further comprising approving a transaction at the transaction terminal in response to the verification.

5. The transaction verification method of claim 1, further comprising communicating transactional information from the processing system to the user via the identifying device.

6. The transaction verification method of claim 5, further comprising enabling the user to disapprove the transaction in response to the transactional information.

7. The transaction verification method of claim 1, further comprising assigning a plurality of persons to the user account in addition to the user, wherein the plurality of users have at least some access to the user account.

8. The transaction verification method of claim 1, further comprising generating a profile.

9. The transaction verification method of claim 1, further comprising disapproving the transaction in response to determining a preprogrammed profile entry designating the transaction.

10. The transaction verification method of claim 1, further comprising initiating an action selected from a group of actions, each action associated with at least one profile, the group consisting of: selecting a type of the remote identification, selecting the identifying device, determining a characteristic pertaining to the transaction, an action based on the characteristic pertaining to the transaction, an action based upon an amount of money involved in the transaction, an action based upon a time of the transaction, an action based upon a user preference, an action based upon a system preference and some other action based upon a programmatic rule.

11. The transaction verification method of claim 1, wherein the request for remote identification data does not reach the identifying device, communicating the request for remote identification to a second identifying device.

12. The transaction verification method of claim 1, wherein communicating the request for remote identification further includes communicating the request for remote identification data effectively simultaneously to a plurality of remote identification devices.

13. The transaction verification method of claim 1, wherein communicating the request for remote identification further includes prompting input used to select at least one of the identifying device and a type of the remote identification data.

14. The transaction verification method of claim 1, wherein communicating the request for remote identification further includes automatically determining at least one of the identifying device and a type of the remote identification data according to a particular of the transaction.

15. The transaction verification method of claim 1, wherein communicating the request for remote identification data to the identifying device includes communicating the request for remote identification data to an identifying device selected from a group consisting of at least one of: a cellular telephone, a pager, a personal digital assistant, a global positioning receiver and a hand held device.

16. The transaction verification method of claim 1, wherein communicating the remote identification data includes communicating remote identification data from a delegate authorized to act on behalf of the user.

17. The transaction verification method of claim 1, further comprising retrieving the stored authentication data from a memory remote from the processing system.

18. The transaction verification method of claim 1, wherein receiving the remote identification data includes receiving live capture data.

19. The transaction verification method of claim 1, wherein receiving the remote identification data includes retrieving stored data from memory.

20. The transaction verification method of claim 1, further comprising communicating the remote identification data from the identifying device to the processing system.

21. The transaction verification method of claim 1, wherein communicating the identifying data further includes authorizing the transaction if the identifying data is communicated within a predetermined transaction time period.

22. The transaction verification method of claim 1, wherein communicating the identifying data further includes denying the transaction if the identifying data is communicated outside of a predetermined transaction time period.

23. The transaction verification method of claim 22, wherein communicating the identifying data further includes authorizing the transaction if the identifying data is communicated within a subsequent period outside of the predetermined transaction time period.

24. The transaction verification method of claim 1, further comprising, on a subsequent attempt by the user to authenticate, causing the user to provide the remote identification data to the identifying device without providing an ID.

25. The transaction verification method of claim 1, wherein communicating the verification further includes communicating remote identification data selected from a group comprising: a token, a password, a biometric record and proximity data descriptive of a location of the identifying device.

26. The transaction verification method of claim 1, wherein communicating the verification further includes communicating the verification only if remote identification data is communicated from multiple users.

27. The transaction verification method of claim 1, wherein communicating the verification further includes communicating the verification only if remote identification data is communicated from a percentage of multiple users.

28. The transaction verification method of claim 1, further comprising disapproving a transaction at the transaction terminal in response to the verification.

29. The transaction verification method of claim 1, further comprising temporarily disabling the transaction verification method.

30. The transaction verification method of claim 1, further comprising storing the stored authentication data in association with a second account.

31. The transaction verification method of claim 1, further comprising storing the remote identification data as updated stored authentication data in response to a sufficient match.

32. A transaction verification method wherein a user has a user account with identifying data unique to that user account, the method comprising:
communicating identifying data unique to a user account to a transaction terminal to authorize a transaction for that user account;
communicating a request for verification of the user account to a processing system, the processing system including access to stored authentication data and to identifying devices for a plurality of user accounts;
communicating a request for remote identification data to an identifying device associated with the user account for which verification is requested;
communicating remote identification data from the identifying device in response to the request therefore; and
determining if the remote identification data communicated from the identifying device sufficiently matches the stored authentication data associated with the user account for which verification is requested, and if it does, communicating verification to the transaction terminal.

33. A transaction verification method wherein a user has a user account with identifying data unique to that user account, the method comprising:
communicating identifying data unique to a user account to a transaction terminal to authorize a transaction for that user account;
communicating a request for verification of the user account to a processing system, the processing system including access to stored authentication data and identifying devices for a plurality of user accounts;
communicating a request for remote identification data to an identifying device associated with the user account for which verification is requested;
communicating remote identification data from the identifying device in response to the request therefore; and
determining if the remote identification data communicated from the identifying device sufficiently matches the stored authentication data associated with the user account for which verification is requested.

34. The transaction verification method of claim 33, further comprising communicating verification to the transaction terminal if it is determined that the remote identification data sufficiently matches the stored authentication data.

35. A transaction verification method wherein a user has a user account with identifying data unique to that user account, the method comprising:
communicating identifying data unique to a user account to a transaction terminal to authorize a transaction for that user account;
communicating a request for verification of the user account to a processing system, the processing system including access to identifying devices for a plurality of user accounts;
communicating a request for remote identification data to an identifying device associated with the user account for which verification is requested, wherein the identifying device has access to stored authentication data; and
communicating verification to the transaction terminal if remote identification data is communicated to the identifying device sufficiently matches the stored authentication data associated with the user account for which verification is requested.

36. A transaction verification method wherein a user has a user account with identifying data unique to that user account, the method comprising:
communicating identifying data unique to a first user account to a transaction terminal to authorize a transaction for the first user account;
communicating a request for verification of the first user to a processing system, the processing system including access to stored authentication data and identifying devices for a plurality of user accounts;
communicating a request for remote identification data to an identifying device associated with a second user; and
communicating verification to the transaction terminal if remote identification data is communicated from the identifying device which sufficiently matches the stored authentication data associated with the second user.

37. The method of claim 36, further comprising approving the transaction in response to the sufficient match and affirming input from the second user.

38. The method of claim 36, further comprising denying the transaction in response to input from the second user.

39. A transaction verification method wherein a user has a user account with identifying data unique to that user account, the method comprising:
communicating remote identification data and a transaction terminal identification from an identifying device associated with a user account to a processing system, the processing system including access to stored authentication data and to identifying devices for a plurality of user accounts; and
in response to a request for verification from a transaction terminal, communicating verification to the transaction terminal if the transaction terminal is identified by the transaction terminal identification and the remote identification data communicated from the identifying device sufficiently matches stored authentication data associated with the user account.

40. An apparatus, comprising:
a transaction terminal for authorizing a transaction configured to receive identifying data unique to a user account;
an identifying device associated with the user account and configured to receive remote identification data from a user in response to a request for remote identification data;
a processing system in communication with the identifying device including access to stored authentication data and identifying device's for a plurality of user accounts, wherein the processing system receives the remote identification data from the identifying device; and
program code executed by the processing system configured to both initiate sending the request for remote identification data to the identifying device and to send verification to the transaction terminal after determining if the remote identification data matches the stored authentication data.

41. The apparatus of claim 40, wherein the program code initiates denying the transaction at the transaction terminal if the remote identification data does not sufficiently match the stored authentication data.

42. The apparatus of claim 40, wherein the program code initiates executing a default action included in a profile if the remote identification data does not sufficiently match the stored authentication data.

43. The apparatus of claim 40, wherein the program code initiates approving the transaction at the transaction terminal in response to the verification.

44. The apparatus of claim 40, wherein the program code initiates communicating transactional information from the processing system to the user via the identifying device.

45. The apparatus of claim 40, wherein the user disapproves the transaction in response to the transactional information.

46. The apparatus of claim 40, wherein the user comprises a plurality of persons including access to the user account.

47. The apparatus of claim 40, wherein the program code initiates generating a profile.

48. The apparatus of claim 40, wherein the program code initiates disapproving the transaction in response to determining a preprogrammed profile entry designating the transaction.

49. The apparatus of claim 40, wherein the program code initiates communicating the request for remote identification to a second identifying device when the request for remote identification data does not reach the identifying device.

50. The apparatus of claim 40, wherein the program code initiates determining the identifying device from a profile.

51. The apparatus of claim 40, wherein the identifying device is selected from a group consisting of at least one of: a cellular telephone, a pager, a personal digital assistant, a global positioning receiver and a hand held device.

52. The apparatus of claim 40, wherein the remote identification data is selected from a group consisting of at least one of a: password, user identifier, token, geographic position and biometric record.

53. The apparatus of claim 40, wherein the stored authentication data is retrieved remotely from the processing system.

54. The apparatus of claim 40, wherein the remote identification data comprises live capture data.

55. The apparatus of claim 40, wherein the remote identification data is retrieved from memory.

56. The apparatus of claim 40, wherein the program code, on a subsequent attempt by the user to authenticate, causes the user to provide the remote identification data to the identifying device without providing an ID.

57. The apparatus of claim 40, wherein the remote identification data includes proximity data descriptive of a location of the identifying device.

58. The apparatus of claim 40, wherein the transaction terminal disapproves the transaction in response to the verification.

59. The apparatus of claim 40, wherein the program code initiates temporarily disabling verification processes.

60. The apparatus of claim 40, wherein the program code initiates storing the stored authentication data in association with a second account.

61. The apparatus of claim 40, wherein the program code initiates storing the remote identification data as updated stored authentication data in response to a match.

62. The apparatus of claim 40, wherein the remote identification data is provided by a different user than a user who initiated the transaction.

63. The apparatus of claim 62, wherein the transaction is approved only in response to the sufficient match and affirming input from the different user.

64. The apparatus of claim 62, wherein the transaction is denied in response to disaffirming input from the different user.

65. An apparatus, comprising:
a transaction terminal for authorizing a transaction configured to receive identifying data unique to a user account;
an identifying device associated with the user account and configured to receive remote identification data from a user in response to a request for remote identification data, the identifying device including access to stored authentication data;
program code executed by the identifying device configured compare the remote identification data to the stored authentication data to determine if there is a sufficient match, and to generate a signal communicating the results of the comparison; and
a processing system including access to the identifying device, along with a plurality of other identifying devices, wherein the processing system communicates verification to the transaction signal in response to receiving the signal from the identifying device.

66. A program product, comprising:
a program resident on a processing system including access to stored authentication data, and identifying devices for a plurality of user accounts, as well as to remote identification data from an identification device associate with a user account, wherein the program determines if the remote identification data matches the stored authentication data and initiates communicating verification to a transaction terminal configure to authorize a transaction in response to the verification; and
a signal bearing medium bearing the program.

67. The program product of claim 66, wherein the signal bearing medium includes at least one of a recordable medium and a transmission-type medium.
